(19) United States
(12) Patent Application Publication
(10) Pub. No.: US 2023/0264278 A1
(43) Pub. Date: Aug. 24, 2023

(54) CIRCULAR SAW BLADE EQUIPPED WITH TIP HAVING STEPPED PORTION

(71) Applicant: Jong Gab KIM, Paju-si (KR)

(72) Inventor: Jong Gab KIM, Paju-si (KR)

(21) Appl. No.: 18/010,248

(22) PCT Filed: Aug. 26, 2021
(86) PCT No.: PCT/KR2021/011416

§ 371 Date: Dec. 14, 2022

(30) Foreign Application Priority Data
Sep. 2, 2020 (KR) 10-2020-0111809

(51) Int. Cl. B23D 61/02; B23D 59/00

(52) U.S. Cl. CPC B23D 61/02; B23D 59/006

(57) ABSTRACT

Disclosed is a circular saw for cutting metals, the circular saw including a body formed in a disk shape; a plurality of saw blade support portions protruding to the outside of a disk along the circumference of the body and integrally formed with the body; a plurality of cutting tips including an upper portion including a cutting edge formed on the upper end of a surface facing the rotation direction of the body, a lower portion extending from one end of the upper portion toward the center of the body, and a stepped portion formed between the upper portion and the lower portion; and a plurality of seating portions formed to be recessed from the saw blade support portions toward the center of the body and including a space for seating each of the cutting tips, wherein the upper portion is thicker than the saw blade support portions, the lower portion and the saw blade support portions have identical thicknesses, and the stepped portions of the cutting tips are spaced apart by the same distance from the center of the body.

### TECHNICAL FIELD

Various embodiments of the present invention relate to a tip having a stepped portion and a circular saw having the tip.

### BACKGROUND ART

In general, a circular saw blade has a circumference around which a cutting edge is formed, and is used to cut a metal pipe, an iron plate, a round bar, and various industrial materials containing nonferrous metals (Cu, Al, etc.).

Since a circular saw blade is commonly used to cut metals having very high strength and hardness, a cutting tip for metal cutting is attached to the circular saw blade through high-frequency welding. During a cutting operation, the cutting tip comes into direct contact with a metal material, the surface of the metal material is cut little by little by the cutting tip, and the cutting target is completely cut.

Accordingly, a cutting tip requires very high strength and hardness. To ensure machinability and wear resistance, the cutting tip is made of an alloy such as tungsten carbide or cermet.

However, as described above, the cutting tip of a circular saw blade for cutting metal is mainly used to cut metal materials having very strong strength and hardness, cutting tips made of durable materials are also prone to wear and breakage when repeatedly used.

In particular, when cutting chips generated during a cutting operation are not smoothly discharged to the outside of the blade portion of a circular saw blade, interference occurs due to contact between a cutting tip and a cutting target. At this time, an excessive load may be applied to the cutting tip, which reduces the strength of the cutting tip. In addition, the cutting tip may be easily worn or damaged. Consequently, the cut surface of the cutting target is coarse, and precision cutting is difficult.

### DISCLOSURE

### Technical Problem

Therefore, the present invention has been made in view of the above problems, and it is one object of the present invention to provide a tip having a stepped portion and a circular saw having the tip by adding novelty and advanced technology to the parent patent, Korean Patent No. 10-1495878 (registration on Feb. 16, 2015) “CIRCULAR SAW FOR CUTTING METALS”. According to the present invention, by reducing contact with a cutting target and reducing the influence of interference and friction, breakage and wear of the cutting tip may be minimized.

### Technical Solution

In accordance with one aspect of the present invention, provided is a circular saw including a body formed in a disk shape; a plurality of saw blade support portions protruding to an outside of a disk along a circumference of the body and integrally formed with the body; a plurality of cutting tips including an upper portion including a cutting edge formed on an upper end of a surface facing a rotation direction of the body, a lower portion extending from one end of the upper portion toward a center of the body and having a rearwardly concave front surface, and a stepped portion formed between the upper portion and the lower portion; and a plurality of seating portions formed to be recessed from the saw blade support portions toward the center of the body and including a space for seating each of the cutting tips, wherein the cutting tips include a recessed portion in which rear ends of both sides are recessed in a rotation direction of the cutting tips, the upper portion is thicker than the saw blade support portions, the lower portion and the saw blade support portions have identical thicknesses, and the stepped portions of the cutting tips are spaced apart by the same distance from a center of the body.

According to various embodiments, the cutting tip may include a first surface, a curved surface extending from a first edge of the first surface, a flat surface continuously extending in a first direction from one end of the curved surface, a second surface including a cutting edge in a region in contact with the first surface, a third surface extending in the first direction from a second edge facing the first edge of the first surface, a fourth surface that is continuous with the second surface and the third surface and has a chamfered edge where the second surface and the third surface contact, a fifth surface formed along edges of the first, second, third, and fourth surfaces and including a stepped portion formed from one edge of the second surface to one edge of the third surface, and a sixth surface formed along the edges of the first, second, third, and fourth surfaces and including a stepped portion formed from the other edge of the second surface to the other edge of the third surface.

### Advantageous Effects

According to various embodiments, a tip having a stepped portion and a circular saw having the tip are configured so that by-products generated during cutting a cutting target can be easily discharged to the outside along the stepped portion of the tip, and interference due to contact with the cutting target can be minimized.

According to various embodiments, the tip having a stepped portion and the circular saw having the tip can reduce interference and friction by reducing contact with a cutting target, thereby minimizing breakage and wear of cutting tips.

According to various embodiments, since the tip having a stepped portion and the circular saw having the tip include a stepped portion, a region requiring strength for cutting has a sufficient thickness, thereby improving cutting performance.

According to various embodiments, since the circular saw having a tip having a stepped portion has a pocket on which a tip is seated, detachment of the tip can be prevented, and adhesion can be increased by increasing a brazing area.

A circular saw blade according to the present invention has a lower front surface formed to be concave toward the rear. By introducing a cutting tip including a recessed portion formed by recessing the rear ends of both sides in the rotation direction, cutting chips generated during a cutting operation can be easily discharged to the outside of the cutting tip of the circular saw blade, thereby reducing a load applied to the cutting tip. In addition, by minimizing contact between the cutting tip and a cutting target, interference can be reduced, and wear and breakage of the cutting tip can be prevented, thereby improving the durability of the circular saw blade.

In particular, since the circular saw blade according to the present invention has excellent durability, the number of reprocessing or replacement of cutting tips can be reduced, and thus process costs can be reduced. In addition, decrease in strength and hardness of cutting edges can be reduced, thereby improving the machinability and wear resistance of the circular saw blade.

In addition, the circular saw blade according to the present invention is configured so that the attachment surface of a saw blade portion to which the rear surface of a cutting tip is attached is inclined −20° to −30° in a direction opposite to the rotation direction of the body with respect to the center line of the body. With this configuration, by reducing pressure applied to the cutting tip, breakage of the cutting edge of the cutting tip can prevented. In addition, separation of the cutting tip from the saw blade portion of the body can be prevented.

In addition, the circular saw blade according to the present invention is configured so that an upper front surface connected to a cutting edge is formed to be inclined −20° to −30° in the rotation direction of a body with respect to the horizontal line perpendicular to the center line of the body. With this configuration, the moment the cutting edge comes into contact with a cutting target, the cutting edge can cut the cutting target while entering the optimal angle. Thus, cutting efficiency can be excellent. In addition, an aesthetically pleasing cut surface can be obtained, allowing precision machining.

In addition, in the circular saw blade according to the present invention, when a cutting tip is attached to a saw blade portion, to form the front side wall of a recessed portion at an angle coincident with the center line of a body, the front side wall is formed to be inclined toward the rear upper side from the front upper end of both sides. With this configuration, by securing the strength of the cutting tip and minimizing the interference between the cutting tip and the cutting target, the durability of the circular saw blade can be improved.

In addition, according to the present invention, a front side wall and the side of a body form a sloping side slope so that the recessed thickness of the front side wall at the center line is reduced. Thus, cutting force can be maintained, and frictional force with a cutting target can be minimized, thereby providing a circular saw blade having optimized durability.

### DESCRIPTION OF DRAWINGS

FIG. 1 is a perspective view of a circular saw including a tip having a stepped portion according to various embodiments.

FIG. 2A is an enlarged view of area A of the circular saw including a tip having a stepped portion according to various embodiments shown in FIG. 1.

FIG. 2B is an enlarged view from another direction of area A of the circular saw including a tip having a stepped portion according to various embodiments shown in FIG. 1.

FIG. 3 is a top view of a circular saw including a tip having a stepped portion according to various embodiments.

### BEST MODE

Hereinafter, the structure of a circular saw according to various embodiment of the present invention will be described in detail.

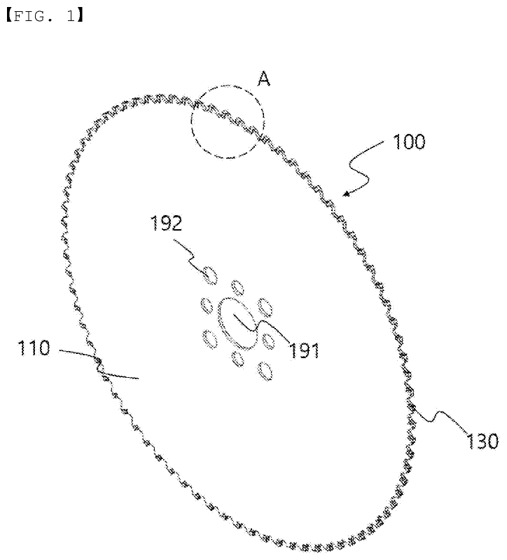

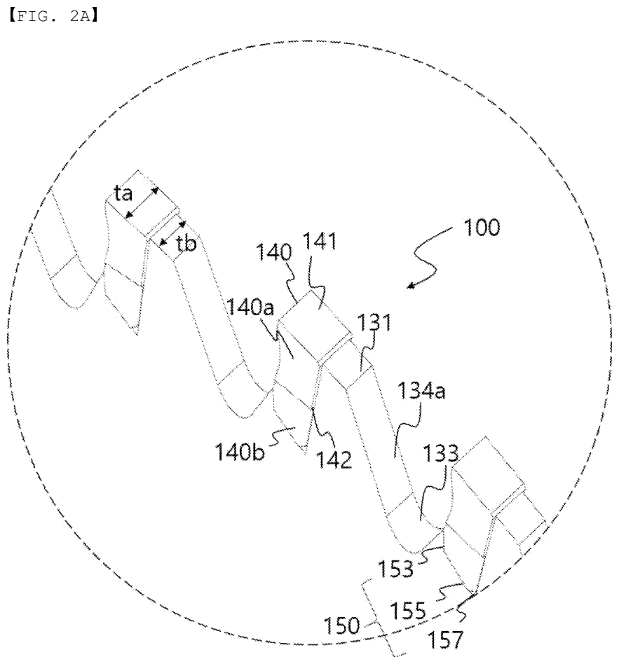

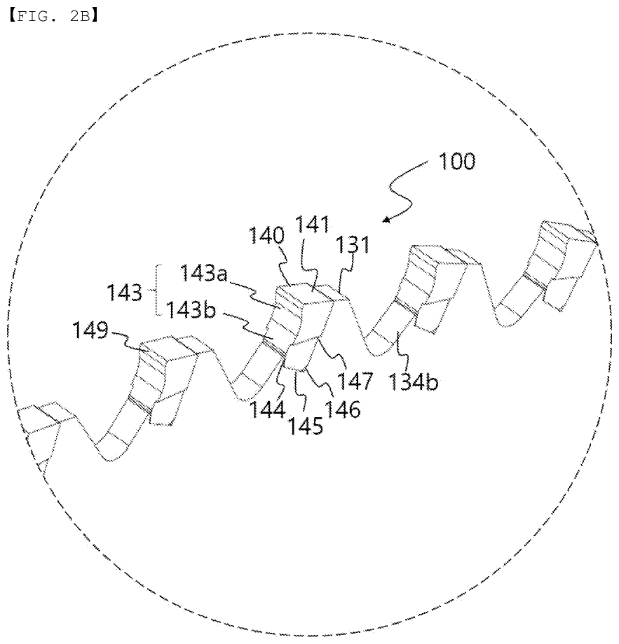

FIG. 1 is a perspective view of a circular saw including a tip having a stepped portion according to various embodiments, FIG. 2A is an enlarged view of area A of the circular saw including a tip having a stepped portion according to various embodiments shown in FIG. 1, and FIG. 2B is an enlarged view from another direction of area A of the circular saw including a tip having a stepped portion according to various embodiments shown in FIG. 1.

Referring to FIG. 1, a circular saw 100 has a circular body in which cutting edges are formed, and may cut a member such as a pipe, a steel plate, and a nonferrous metal, or may create a groove.

The circular saw 100 may be mounted on a cutter (not shown) and rotated, and may include a body 110 formed in a circular shape and a plurality of saw blade support portions 130 formed along the circumference of the body.

The body 110 of the circular saw 100 may be mounted on a cutter, and may be rotated by a driver provided in the cutter. By rotation of the body 110 of the circular saw 100, the cutting edges of the saw blade support portions 130 may be in contact with a cutting target to shape or cut the cutting target. The body 110 may rotate in one direction, and the cutting edges may be formed on each surface facing the rotation direction of the saw blade support portions 130.

The circular saw 100 may include an opening 191 for mounting on a cutter. In addition, the circular saw 100 may include openings 192 that are formed along the periphery of the opening 191 and are smaller than the opening 191. The small openings 192 may be used as auxiliary coupling holes for additional coupling with the cutter to prevent the circular saw 100 for idling.

The body 110 may include a cutout (not shown) to prevent deformation due to heat generated during a cutting process. The saw blade support portions 130 may include cut-out grooves arranged at regular intervals for dispersing stress applied to saw teeth.

Referring to FIGS. 2A and 2B, the circular saw 100 may include the body 110, a plurality of saw blade portions 130, a plurality of cutting tips 140, and a plurality of seating portions 150. The body 110 may be formed in a disk shape.

The saw blade support portions 130 may be formed to protrude to the outside of the disk along the circumference of the body 110. For example, the saw blade support portions 130 may include a protrusion 131 protruding in an outward direction from the center of the circle.

According to various embodiments, the saw blade support portions 130 may be arranged at regular intervals along the circumference. For example, the saw blade support portions 130 may be disposed at a predetermined angle from the center of the circle. Specifically, when an angle formed by each of the saw blade support portions 130 from the center of the circle is 2 degrees, the saw blade support portions 130 may be 180 pieces.

According to various embodiments, the saw blade support portions 130 may include protrusions 131 and seating portions 150.

According to various embodiments, the seating portions 150 may be formed to be recessed from the saw blade support portions 130 toward the center of the body 110. The seating portions 150 may have grooves formed by being recessed from the saw blade support portions 130 (or the body 110). The grooves may be spaces in which a plurality of cutting tips 140 are seated and received.

According to various embodiments, the cutting tips 140 may be coupled to the body 100 by being fitted to the seating portions 150.

According to various embodiments, the cutting tips 10 may be bonded to the seating portions 150 by high-frequency welding or the like.

According to various embodiments, the cutting tips 140 may include a first surface 141, a second surface 143, a third surface 147, a fourth surface 145, a fifth surface 148, and a sixth surface facing the fifth surface.

According to various embodiments, the first surface 141 and the cutting tips 140 may face the outside of the body 110 (or the radial direction of the body 110). The second surface 143 may include a curved surface 143a formed to extend from the first edge of the first surface, a flat surface 143b formed to continuously extend in a first direction from one end of the curved surface, and a cutting edge 149 formed in a region in contact with the first surface. The third surface 147 may be formed to extend in a first direction from a second edge facing the first edge of the first surface 141. The fourth surface 145 may be formed to be connected to the second and third surfaces 143 and 147, and edges in contact with the second and third surfaces 143 and 147 may be chamfered. The fifth surface 148 may be a surface formed by being surrounded along the edges of the first, second, third, and fourth surfaces 141, 143, 147, and 145. The sixth surface may be formed to face the fifth surface 148, may be formed along the edges of the fifth surface 148 including a stepped portion 142 formed from one edge of the second surface to one edge of the third surface, the first surface 141, the second surface 143, the third surface 147, and the fourth surface 145, and may include a stepped portion formed from the other edge of the second surface to the other edge of the third surface.

According to various embodiments, the curved surface 143a may be formed as a flat surface having a slope at a portion in contact with the cutting edge 149. According to various embodiments, the cutting tip 140 may include an upper front surface (e.g., the second surface 143) connected to the cutting edge 149 and formed to be inclined with respect to a rear upper side (e.g., the first surface 141). The upper front surface may be formed to be inclined 20° to −30° in the direction of rotation of the body in a horizontal line perpendicular to the center line of the body when the cutting tip 140 is attached to the saw blade support portion 130.

According to various embodiments, the cutting tip 140 is characterized in that side walls forming an upper portion 140a of the second surface 143 (e.g., a front side or a side facing the direction of rotation) are formed to be inclined toward the rear of a lower portion 140b from the upper portion 140a of both sides. The side wall in contact with the second surface 143 and the side surface of the body 110 may have an inclined surface such that a recessed thickness of the side wall in contact with the second surface 143 from a center line is reduced. That is, a portion between the second and third surfaces 143 and 147 may be concave so that the second surface 143 is inclined toward the rear, and may be formed so that the middle region thereof is thin.

According to various embodiments, when the cutter is driven and a cutting target is processed by the cutting edge 149 of the cutting tip 140, the by-products of the cutting target may be guided to the curved surface 143a of the second surface 143, and the guided by-product may be discharged along the stepped portion 142. In this case, due to a flat surface where the curved surface 143a of the second surface 143 meets the cutting edge 149, the by-products may be easily transferred to the curved surface 143a.

When the portion where the curved surface 143a meets the cutting edge 149 is formed as a flat surface having a slope, by-products may be easily discharged by the curved surface 143a recessed in a direction opposite to a rotation direction. In addition, by preventing a sharp decrease in the thickness of the cutting edge 149, damage to the cutting tips 140 may be prevented.

According to various embodiments, the cutting tips 140 may include any one of a hard metal, a cermet, and a cermet hard metal obtained by combing a hard metal and a cermet. The hard metal is a mixture of a carbide having high hardness and a metal having toughness. Since the hard metal has both hardness and toughness, the hard metal is used in metal cutters or various materials and parts. The cermet is a TiC—Ni—Mo-based hard metal, and may include ceramic properties and metallic properties. For example, cermet tools have ceramic properties such as hardness, wear resistance, acid resistance, and chemical resistance and metallic properties such as toughness and plasticity. The cermet hard metal has both the advantages of a hard metal and the advantages of a cermet, and thus may maximize metallic properties. Accordingly, the cement hard metal has excellent heat resistance and oxidation resistance, and has a small coefficient of friction. Thus, the cement hard metal may reduce heat generation due to friction with a cutting target, increase cutting speed, and prevent damage to the cutting tips 140 due to friction.

According to various embodiments, the material of the cutting tips 140 may be selected in consideration of the type of a cutting target and a cutting shape.

According to various embodiments, to ensure high durability, machinability, and wear resistance, a portion where the cutting edge 149 is formed may be additionally coated with a cermet, a hard metal, or a cermet hard metal.

According to various embodiments, the cutting tips 140 may include the upper portion 140a including the cutting edge 149 formed on the upper end of a surface facing the rotation direction of the body 110, the lower portion 140b extending from one end of the upper portion 140a, and the stepped portion 142 formed between the upper portion 140a and the lower portion 140b.

According to various embodiments, the upper portion 140a may be formed to be thicker than the saw blade support portions 130, and the lower portion 140b may be formed to have a thickness equal to the thickness of the saw blade support portions 130. For example, the saw blade support portions 130 may have a thickness of tb, and the upper portion 140a may have a thickness of ta. In this case, ta may be greater than tb. Both the lower portion 140b and the saw blade support portions 130 may have a thickness of ta. Due to a thickness difference between the upper portion 140a and the lower portion 140b, the stepped portion 142 having a step shape may be formed on the interface between the upper portion 140a and the lower portion 140b. The distance from the stepped portions 142 formed on each cutting tip to the center of the body 110 may be the same.

According to various embodiments, the thickness of the fifth surface 148 and the thickness of the sixth surface facing the fifth surface may be different with respect to the stepped portion 142. Regions corresponding to the upper portion 140a in the fifth surface 148 and the sixth surface may protrude to both sides of the body 110 at equal intervals. A region corresponding to the lower portion 140b in the fifth surface 148 may be formed continuously with both sides of the body 110. For example, the lower portion 140b of the fifth surface 148 and one surface of the body 110 may form the same flat surface, and the lower portion 140b of the sixth surface facing the fifth surface and the other surface of the body 110 may form the same flat surface.

According to various embodiments, since the cutting tip 140 includes the stepped portion 142, the strength of the upper portion 140a on which the cutting edge 149 is formed is increased, and the thickness of the lower portion 140b is reduced. Thus, during a cutting process, a region that does not interfere with a cutting target may be maximized, thereby reducing heat generation and physical contact, thereby preventing breakage of the cutting tips 140.

According to various embodiments, the cutting tips 140 may include a first chamfered region 144 formed by removing an edge at a region where the second surface 143 and the fourth surface 145 contact each other and a second chamfered region 146 formed by removing an edge at a region where the third surface 147 and the fourth surface 145 contact each other. In the cutting tips 140, an edge where the fourth surface 145 and the second surface 143 facing the rotation direction (e.g., counterclockwise in FIGS. 1, 2A, and 2B) of the body 110 contact each other may be chamfered, and an edge where the fourth surface 145 and a surface opposite to the second surface 143 facing the rotation direction of the body 110 contact each other may be chamfered.

According to various embodiments, the seating portions 150 may include a seating surface 155 and an inclined surface 153 formed on one end of the seating surface 155. The other end of the seating surface 155 may include a surface extending in a vertical direction (e.g., the radial direction of the body 110 or an angle within 20 degrees in the radial direction) from the seating surface 155. The seating surface 155 may be in contact with the third surface 145 of the cutting tip 140.

According to various embodiments, the inclined surface 153 of the seating portion 150 may be in contact with the first chamfered region 144 of the cutting tip 140. The second chamfered region 146 of the cutting tip 140 may be formed by a chamfering process for perfect adhesion to the seating portion 150.

According to various embodiments, the seating portions 150 may be formed in a pocket shape. The seating portion 150 may be formed to be in contact with the entire portion of the third surface 147 of the cutting tip 140, may be formed so that the seating surface 155 is in contact with the fourth surface 145 of the cutting tip 140, and may be formed so that the inclined surface 153 of the seating portion 150 is in contact with the first chamfered region 144. With this configuration, adhesion between the cutting tips 140 and the seating portions 150 may be increased.

According to various embodiments, due to the seating portions 150 formed in a pocket shape, when the cutting tips 140 and the seating portions 150 are adhered, the welding area of the cutting tips 140 may be increased, and adhesion may be increased. In addition, pressure applied in the direction (e.g., clockwise) opposite to the rotation direction of the body 110 by friction with a cutting target during a cutting process is dispersed on the fourth surface 145, the third surface 147, the first chamfered region 144, and the second chamfered region 146 of the cutting tip 20, and the pressure is offset, thereby preventing separation of the cutting tips 140 from the saw blade support portions 130 of the body 110.

According to various embodiments, the inclined surface 153 of the seating portion 150 may be formed to extend and contact a portion of the second surface 143 of the cutting tip 140, e.g., a portion of the flat surface 143b of the cutting tip 140.

According to various embodiments, the saw blade support portions 130 of the body 110 may include the protrusion 131 protruding from the circumferential surface of the body 110 and a curved portion 133 recessed from the circumferential surface. The saw blade support portions 130 may include a first inclined surface 134a formed to connect the saw blade portion 131 and the curved portion 133. The first inclined surface 134a may be formed to face a direction opposite to the rotation direction (e.g., counterclockwise) of the body 110. The curved portion 133 may be formed in a curved surface, and the first inclined surface 134a may be formed in a flat surface from one end of the curved portion 133 toward the protrusion 131.

According to various embodiments, the saw blade support portions 130 of the body 110 may include a second inclined surface 134b formed to extend from the other end of the curved portion 133 to the flat surface 143b of the second surface 143 of the cutting tip 140. The second inclined surface 134b may be formed on the same flat surface as the second surface 143. For example, the second inclined surface 134b may be formed continuously with the second surface 143.

According to various embodiments, the first surface 141 of the cutting tip 140 may be positioned higher than the top surface of the protrusion 131. For example, a step may be formed between the cutting tip 140 and the protrusion 131.

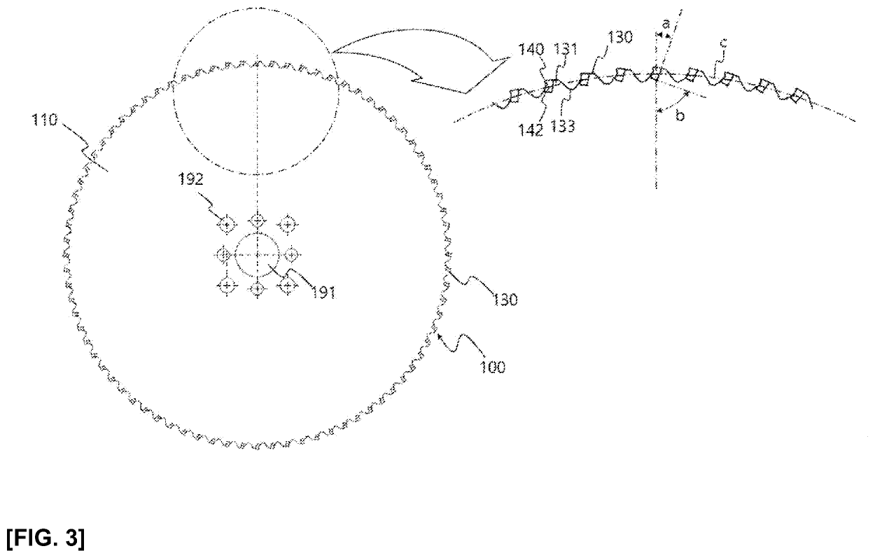

FIG. 3 is a top view of a circular saw including a tip having a stepped portion according to various embodiments.

Referring to FIG. 3, the body 110 may be formed in a circular shape, and may include the saw blade support portions 130 disposed along a circumference (c). The saw blade support portions 130 may include the protrusion 131 extending from the circumference (c) and the curved portion 133 recessed from the circumference (c).

According to various embodiments, the stepped portion 142 at which the thickness of the cutting tip 140 is changed may be disposed so as to be in contact with the circumference. For example, the stepped portion 142 of the cutting tip 140 may be formed to be perpendicular to the radial direction extending from the center of the body 110, and distances perpendicular to the stepped portion 142 from the center of the body 110 may be the same.

According to various embodiments, the upper portion 140a including the cutting edge (e.g., the cutting edge 149 of FIG. 2B) of the cutting tip 140 is thick, and may have a thickness for cutting or processing a cutting target. When cutting with a thickness of to of FIG. 2A is performed by the cutting edge 149, the stepped portion 142 may be included for easy discharge of by-products (e.g., cutting chips) generated during processing of a cutting target. The lower portion 140b, which is distinguished from the upper portion 140a by the stepped portion 142, may be formed thin.

According to various embodiments, the thin lower portion 140b may be formed in a flat surface with the body 110, and generated by-products may be easily discharged through the lower portion 140b.

According to various embodiments, the third surface 147 of the cutting tip 140 in contact with the seating portion 150 may be formed to have a constant slope (a) with respect to the radial direction extending from the center of the circle. The slope (a) is approximately 20 to 30 degrees. As another example, in the circular saw blade, the seating portion 150 of the saw blade support portion 130 to which the rear surface of the cutting tip 140 is attached may be formed to be inclined by −20° to −30° in a direction opposite to the rotation direction of the body with respect to the center line of the body 110.

According to various embodiments, the fourth surface 145 of the cutting tip 140 in contact with the seating portion 150 may be formed to have a constant slope (b) with respect to the radial direction. The slope (b) is approximately 65 to 75 degrees. When the slope (b) is less than 65 degrees, a contact load is transmitted to the body 110 during a cutting process. In a direction corresponding to the mounting angle of the cutting tip 140, i.e., pressure generated while the cutting edge 149 comes into contact with the surface of a cutting target acts in a direction consistent with the slope or curved surface of the second surface 143, a welded portion is damaged, and the cutting tip 140 is detached.

According to various embodiments, when the cutting tips 140 are attached to the seating portions 150 of the saw blade support portions 130 by welding, the cutting tips 140 are attached with the slope (b), and the slope angle of the cutting tips 140 and the slope of each surface formed on the cutting tips act in a complex way, so that an optimal angle at which the cutting edge 149 protrudes toward the rotational direction of the body 110 may be derived.

The structure of the cutting tip having the stepped portion according to various embodiments of the present invention and the structure of the circular saw including the cutting tips have been described. Hereinafter, with reference to the drawings of the present specification, operation of the cutting tip having the stepped portion and operation of the circular saw including the cutting tips will be described in detail.

Referring to FIG. 2B, the cutting tips 140 may include the first surface 141 facing the outside of the body 110 (or the radial direction of the body 110), the curved surface 143a extending from a first edge of the first surface, the flat surface 143b continuously extending in the first direction from one end of the curved surface, the second surface 143 including the cutting edge 149 in a region in contact with the first surface, the third surface 147 extending in the first direction from a second edge facing the first edge of the first surface, the fourth surface 145 continuous with the second and third surfaces 143 and 147 and having chamfered edges in contact with the second and third surfaces 143 and 147, the fifth surface 148 formed along the edges of the first, second, third, and fourth surfaces 141, 143, 147, and 145 and including the stepped portion 142 formed from one edge of the second surface to one edge of the third surface, and the sixth surface formed along the edges of the first, second, third, and fourth surfaces 141, 143, 147, and 145, including a stepped portion formed from the other edge of the second surface to the other edge of the third surface, and configured to face the fifth surface 148.

According to various embodiments, the first chamfered region 144 and the second chamfered region 146 of the fourth surface 145 may be used for easy installation of the cutting tip 140 when inserted into the seating portion 150. As the gap between a region facing the seating portion 150 and the seating portion 150 decreases, the width of the chamfered cutting tip decreases. Thus, when the cutting tip 140 is installed so that the narrow part of the cutting tip 140 faces the seating portion 150, the cutting tip 140 may be easily installed on the seating portion 150.

According to various embodiments, the third surface 147 and the fourth surface 145, a portion of the flat surface 143b of the second surface 143 and the seating portion 150 may be bonded using various bonding methods, such as high-frequency brazing welding.

Referring to FIG. 1, the circular saw 100 may include the opening 191 for mounting formed in the body 110. For use of the circular saw 100, the shaft (not shown) of a cutter may be inserted and fixed into the opening 191. To fix the circular saw 100 to the cutter, by coupling a fastening member to the small opening 192, a user may complete installation of the circular saw 100 to the cutter.

The cutter may receive power, and through the driver of the cutter, the circular saw 100 may rotate.

Referring to FIGS. 2A, 2B, and 3, the circular saw 100 may rotate in a direction (e.g., counterclockwise in FIGS. 1, 2A, 2B, and 3) facing the second surface 143 of the cutting tip 140.

When the circular saw 100 of the cutter being driven approaches a cutting target, the cutting target may be cut by the saw blade support portions 130 of the circular saw 100.

Specifically, the cutting target may be cut by the cutting edge 149 positioned at the upper portion of the cutting tip 140 of the circular saw 100. The cutting edge 149 may be formed at an edge where the first surface 141 and the second surface 143 of the cutting tip 140 contact each other. The cutting edge 149 may be formed at the upper edge of the cutting tip 140 having a hexahedral shape, and may be a portion that first meets a cutting target. That is, a cutting target may be cut by the cutting edge 149, a groove may be formed, and then another portion of the circular saw may contact the cutting target.

In addition, the upper portions 140a of the cutting tips 140 may be formed thicker than the saw blade support portions 130, and the lower portions 140b may be formed to have a thickness equal to that of the saw blade support portions 130. For example, the saw blade support portions 130 may have a thickness of tb, and the upper portions 140a may have a thickness of ta. In this case, ta may be greater than tb. Both the lower portions 140b and the saw blade support portions 130 may have a thickness of ta. Due to a difference in thickness between the upper portion 140a and the lower portion 140b, the stepped portion 142 having a step shape may be formed on interface between the upper portion 140a and the lower portion 140b. The distance from the stepped portions 142 formed on each cutting tip to the center of the body 110 may be the same.

As described above, the upper portion 140a and the lower portion 140b may be formed to have different thicknesses. Since the width of the cutting edge 149 of the cutting tip 140 has a thickness of ta, a cutting target is cut by ta which is the thickness of the cutting edge 149. Then, the parts (e.g., the lower portion of the cutting tip 140, the saw blade support portion 131, and the body 110) constituting the circular saw other than the cutting edge 149 are less likely to come into contact with the cutting target, and friction between the cutting target and the circular saw may be reduced, thereby reducing the influence of heat, preventing breakage of the circular saw, and increasing the lifespan of a product.

According to various embodiments, when the stepped portions 142 of the cutting tip 140 are connected to each other, the stepped portions 142 may correspond to the circumference of the body 110 of the circular saw 100. That is, the stepped portions 142 formed on the cutting tips 140 may be spaced apart from the center of the body 110 by the same distance, and may be in contact with the circumference (c) of the body 110.

According to various embodiments, a cutting target may be processed by the upper portion 140a of the cutting tip 140, and by-products of the cutting target may be moved along the second surface 143. With the stepped portion 142 as a boundary, a space may be formed between the lower portion 140b of the cutting tip 140 having a reduced width and the cutting target. Through the space, the by-products of the cutting target may be discharged to the outside. Due to the stepped portions 142 formed along the circumference of the body 110 of the circular saw 100, the by-products may be easily discharged to the outside by rotation of the circular saw 100.

The circular saw (e.g., the circular saw 100 of FIG. 1) according to various embodiments may include a body (e.g., the body 110 of FIG. 1) formed in a disk shape, a plurality of saw blade portions (e.g., the saw blade support portions 130 of FIG. 1) integrally formed with the body so as to protrude to the outside of the disk along the circumference of the body, a plurality of cutting tips (e.g., the cutting tips 140 of FIG. 2A) including an upper portion (e.g., the upper portion 140a of FIG. 2A) including a cutting edge formed on the upper end of the surface facing the rotation direction of the body, a lower portion (e.g., the lower portion 140b of FIG. 2A) extending from one end of the upper portion to the center of the body, and a stepped portion (e.g., the stepped portion 142 of FIG. 2A) formed between the upper portion and the lower portion, and a plurality of seating portions (e.g., the cutting tips 150 of FIG. 2A) formed to be recessed from the saw blade portions to the center of the body and including a space for seating each of the cutting tips. The thickness of the upper portion may be greater than the thickness of the saw blade portions (e.g., thickness tb in FIG. 2A), the thickness of the lower portion may be the same as the thickness of the saw blade portions, and the distance from stepped portions of the cutting tips to the center of the body may be the same.

According to various embodiments, the stepped portions of the cutting tips may be in contact with a circle having the center of the body as the center of the circle.

According to various embodiments, the upper portion may include a curved surface extending from the cutting edge and a flat surface extending from one end of the curved surface toward the lower portion on a surface facing the rotation direction of the body. The lower portion may be formed in a flat surface continuously extending from the flat surface, and may form a surface that is substantially continuous with the surface of the saw blade portion facing the rotation direction of the body.

According to various embodiments, in the lower portion, a portion in contact with a seating surface inserted into one of the seating portions, a surface facing the rotation direction of the seating surface and the body, and an opposing surface may be chamfered.

According to various embodiments, the seating portions may be inclined so as to correspond to the seating surfaces of the cutting tips and a chamfered shape on a surface facing the rotation direction of the body.

According to various embodiments, the seating portions may form an empty space surrounding the seating surfaces of the cutting tips and a chamfered shape on a surface opposite to the rotation direction of the body.

The cutting tip (e.g., the cutting tip 140 of FIG. 2B) according to various embodiments may include a first surface (e.g., the first surface 141 of FIG. 2B), a curved surface (e.g., the curved surface 143a of FIG. 2B) extending from a first edge of the first surface, a flat surface (e.g., the flat surface 143b of FIG. 2B) continuously extending in a first direction from one end of the curved surface, a second surface including a cutting edge (e.g., the cutting edge 149 of FIG. 2B) in a region in contact with the first surface, a third surface (e.g., the third surface 147 of FIG. 2B) extending in the first direction from a second edge facing the first edge of the first surface, a fourth surface (e.g., the fourth surface 145 of FIG. 2B) that is continuous with the second surface and the third surface and has a chamfered edge where the second surface and the third surface contact, a fifth surface (e.g., the fifth surface 148 of FIG. 2B) formed along the edges of the first, second, third, and fourth surfaces and including a stepped portion (e.g., the stepped portion 142 of FIG. 2B) formed from one edge of the second surface to one edge of the third surface, and a sixth surface formed along the edges of the first, second, third, and fourth surfaces and including a stepped portion formed from the other edge of the second surface to the other edge of the third surface.

According to various embodiments, when the cutting tips are seated in the seating portions of the circular saw, the distance from the center of the circular saw to the stepped portion of each cutting tip may be the same, and the stepped portions may be in contact with the circumference of the circular saw.

The methods according to claims of the present invention or the embodiments described in the specification may be implemented in hardware, software, or a combination of hardware and software. In the above-described specific embodiments, elements included in the invention are expressed in singular or plural in accordance with the specific embodiments shown. It should be understood, however, that the singular or plural representations are to be chosen as appropriate to the situation presented for the purpose of description and that the above-described embodiments are not limited to the singular or plural constituent elements. The constituent elements expressed in plural may be composed of a single number, and constituent elements expressed in singular form may be composed of a plurality of elements.

In addition, the present invention has been described with reference to exemplary embodiments, but it should be understood that various modifications may be made without departing from the scope of the present invention. Therefore, the scope of the present invention should not be limited by the embodiments, but should be determined by the following claims and equivalents to the following claims.

1. A circular saw, comprising:
a body formed in a disk shape;
a plurality of saw blade support portions protruding to an outside of a disk along a circumference of the body and integrally formed with the body;
a plurality of cutting tips comprising an upper portion comprising a cutting edge formed on an upper end of a surface facing a rotation direction of the body, a lower portion extending from one end of the upper portion toward a center of the body and having a concave surface, and a stepped portion formed between the upper portion and the lower portion; and
a plurality of seating portions formed to be recessed from the saw blade support portions toward the center of the body and comprising a space for seating each of the cutting tips.

2. The circular saw according to claim 1, wherein the upper portion is thicker than the saw blade support portions, and the lower portion and the saw blade support portions have identical thicknesses;
the stepped portions of the cutting tips are spaced apart by the same distance from a center of the body, and are in contact with a circle having the center of the body as a center of the circle;
the saw blade support portions comprise a seating portion configured to support the cutting tips and to be recessed toward the body;
the cutting tips are configured to face a surface facing a rotation direction of the body, a surface in contact with the body has a slope of “a” with respect to a radial direction of a circle having a center of the body as a center of the circle, and a surface formed on the lower portion and in contact with the seating portions of the saw blade support portions has a slope of “b” with respect to the radial direction; and
the slope “a” is 20 to 30 degrees, and the slope “b” is 65 to 75 degrees.

3. The circular saw according to claim 2, wherein the upper portion comprises a curved surface extending from the cutting edge and a flat surface extending from one end of the curved surface toward the lower portion on a surface facing a rotation direction of the body; and
the lower portion is formed in a plane continuously extending from the flat surface, and forms a continuous surface with a surface of the saw blade support portion facing a rotation direction of the body.

4. The circular saw according to claim 2, wherein, in the lower portion, edges in contact with a bottom surface inserted into one of the seating portions, a surface facing a rotation direction of the body, and a surface opposite to the bottom surface and the surface facing a rotation direction of the body are chamfered.

5. The circular saw according to claim 4, wherein in a region in contact with the cutting tips, the seating portions are formed in a chamfered shape corresponding to a bottom surface of the cutting tips.
